(19) United States
(12) Patent Application Publication
(10) Pub. No.: US 2014/0145927 A1
(43) Pub. Date: May 29, 2014

(54) Method for Providing Identification Information and Related Electronic Device

(71) Applicant: HTC CORPORATION, Taoyuan County (TW)

(72) Inventors: Yu-Chang Chang, Taoyuan County (TW); Horng-Cherng Lai, Taoyuan County (TW); Hung-Shen Yang, Taoyuan County (TW)

(73) Assignee: HTC CORPORATION, Taoyuan County (TW)

(21) Appl. No.: 13/689,660

(22) Filed: Nov. 29, 2012

(51) Int. Cl. G06K 19/00; G06F 3/02

(52) U.S. Cl. CPC G06K 19/00; G06F 3/02
USPC 345/156

(57) ABSTRACT

A method for providing identification information of an electronic device having a screen comprises demonstrating a plurality of selecting objects via the screen when a first button of the electronic device is detected to be activated for a predefined period, and displaying the identification information of the electronic device via the screen when a first selecting object of the plurality of selecting objects is triggered.

### BACKGROUND OF THE INVENTION

1. Field of the Invention

The present invention relates to a method for providing identification (ID) information of an electronic device, and more particularly, to a method for providing the ID information of the electronic device via a screen.

2. Description of the Prior Art

An electronic device, such as mobile phone, GSM modem or device with a built-in phone, has a unique 15-digit International Mobile Equipment Identity number (IMEI) as an identification (ID) of the electronic device. The IMEI can identify a valid electronic device and therefore can be taken as warranty identification.

The IMEI may further be printed as a barcode and stuck on a battery compartment inside the electronic device. Therefore, a user or repairer may use a barcode reader to scan the barcode and obtain the IMEI inside the electronic device. In such a situation, since the barcode is inside the electronic device, the user or repairer needs to open a back cover of the electronic device to use a barcode reader to obtain the IMEI, which causes inconvenience.

Moreover, the electronic device is expected to reduce thickness of a housing, so that the back cover of the electronic device is difficult to be opened for scanning the barcode. Even though the barcode can be directly labeled on the back cover of the electronic device, the cost of labeling the barcode must be increased due to a fine material of the back cover. Thus, there is a need to provide methods for obtaining the IMEI or other ID information.

### SUMMARY OF THE INVENTION

It is therefore an objective of the present invention to provide a method for providing ID information of an electronic device via a screen.

The present invention discloses a method, for providing identification information of an electronic device having a screen. The method comprise demonstrating a plurality of selecting objects via the screen when a first button of the electronic device is detected to be activated for a predefined period, and displaying the identification information of the electronic device via the screen when a first selecting object of the plurality of selecting objects is triggered

The present invention another discloses a non-transitory computer-readable medium embodying a program executable in a computing device. The program comprises code for demonstrating a plurality of selecting objects via the screen when a first button of the electronic device is detected to be activated for a predefined period, and code for displaying the identification information of the electronic device via the screen when a first selecting object of the plurality of selecting objects is triggered.

The present invention further discloses an electronic device, comprising a screen, for displaying data, a processing means, and a storage unit, for storing a program to indicate the processing means to perform the following steps: demonstrating a plurality of selecting objects via the screen when a first button of the electronic device is detected to be activated for a predefined period, and displaying the identification information of the electronic device via the screen when a first selecting object of the plurality of selecting objects is triggered.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A and FIG. 1B respectively illustrate schematic diagrams of an external and functional blocks of an electronic device according to an example of the present invention.

FIG. 2 illustrates a schematic diagram of a process according to an example of the present invention.

FIG. 3A to FIG. 3C illustrate schematic diagrams of a screen displaying ID information according to the process shown in FIG. 2.

### DETAILED DESCRIPTION

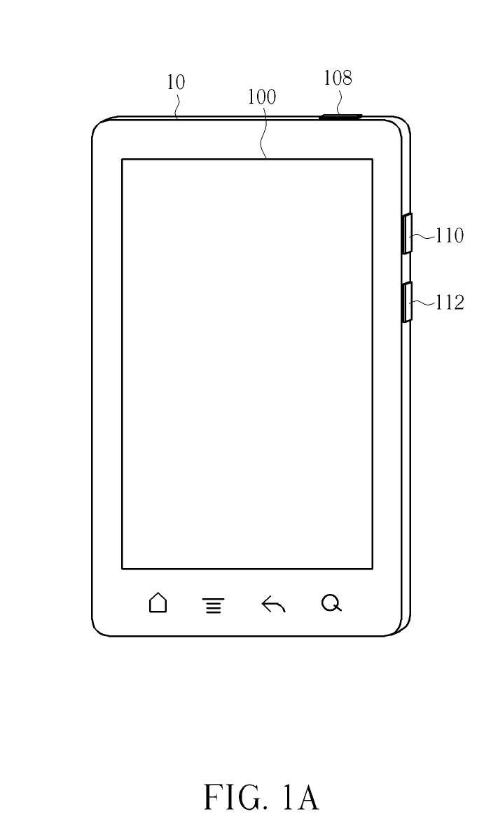

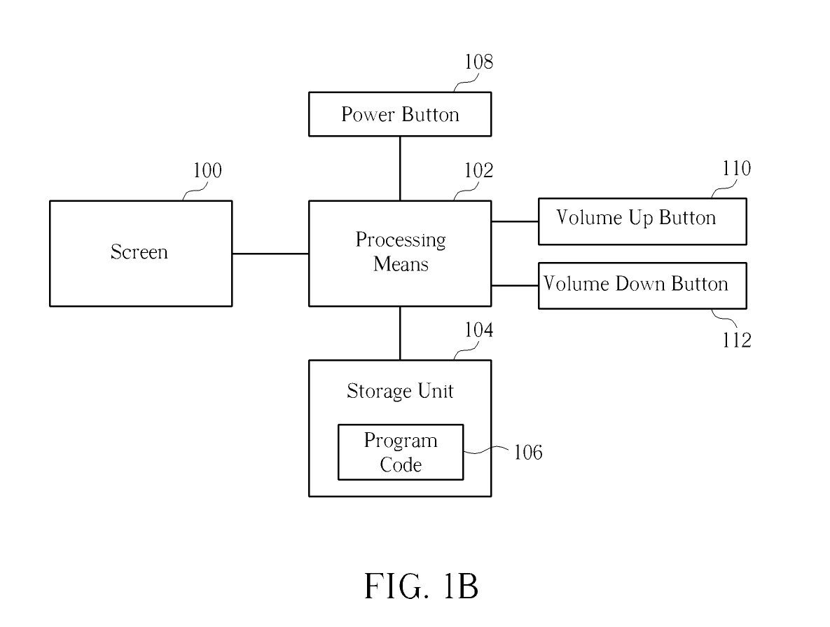

Please refer to FIG. 1A and FIG. 1B. FIG. 1A and FIG. 1B respectively illustrate schematic diagrams of an external and functional blocks of an electronic device 10 according to an example of the present invention. The electronic device 10 may be any electronic product, such as mobile phone, personal digital assistant (PDA), tablet computer, etc., and comprises a screen 100, a power button 108, a volume up button 110 and a volume down button 112 on a housing, and a processing means 102 and a storage unit 104 inside the housing. The screen 100 is a displaying interface for demonstrating image processing results provided by the processing means 102. The power button 108, the volume up button 110 and the volume down button 112 are controlling interfaces. The power button 108 is utilized to control powering on/off, and the volume up button 110 and the volume down button 112 are utilized to adjust sound volume during normal operations of the electronic device 10. In an example of the present invention, the power button 108, the volume up button 110 and the volume down button 112 are further utilized to control the electronic device 10 to display identification (ID) information via the screen 100. The ID information may include, but not limited to, International Mobile Equipment Identity number (IMEI). The storage unit 104 stores program 106, which is compiled to be fetched and executed by the processing means 102, and may be implemented via read-only memory (ROM), random-access memory (RAM), and etc.

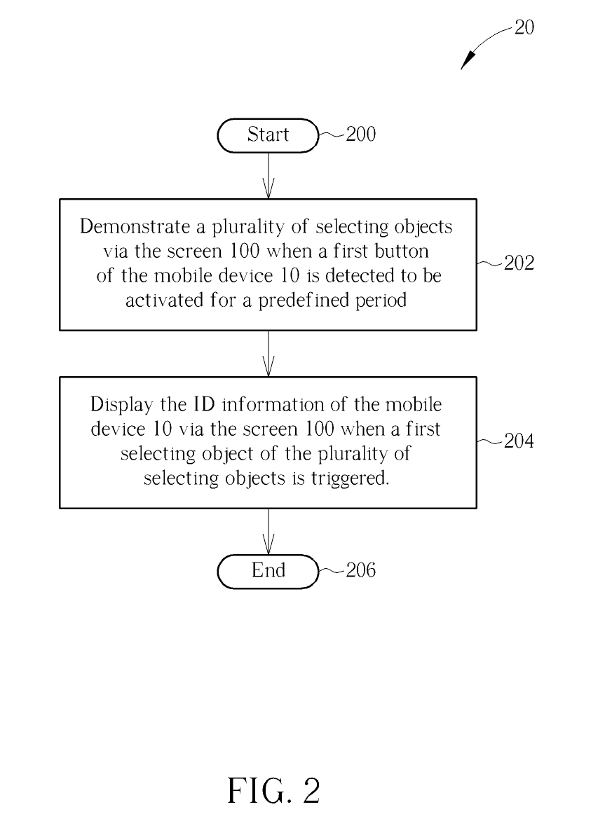

Please refer to FIG. 2. FIG. 2 illustrates a schematic diagram of a process 20 according to an example of the present invention. The process 20 may be compiled into the program 106 and is utilized for providing the ID information of the electronic device 10 via the screen 100. As shown in FIG. 2, the process 20 includes the following steps:

Step 200: Start.

Step 202: Demonstrate a plurality of selecting objects via the screen 100 when a first button of the electronic device 10 is detected to be activated for a predefined period.

Step 204: Display the ID information of the electronic device 10 via the screen 100 when a first selecting object of the plurality of selecting objects is triggered.

Step 208: End.

According to the process 20, after the first button is activated for the predefined period, the electronic device 10 demonstrates the selecting objects via the screen 100, and the ID information of the electronic device 10 is displayed on the screen 100 if a specified object is triggered. In other words, the electronic device 10 may not need to be labeled symbols of the ID information on or inside a back cover, and the user or repairer does not need to open a back cover of the electronic device to use a barcode reader to obtain the ID information.

Noticeably, in process 20, the first button may be any existing hardware buttons of the electronic device 10, such as the power button 108, the volume up button 110 or the volume down button 112 shown in FIG. 1A, and is designed by manufactures. In the following embodiment, the first button is represented as the power button 108 for illustrating the operation of the process 20 clearly.

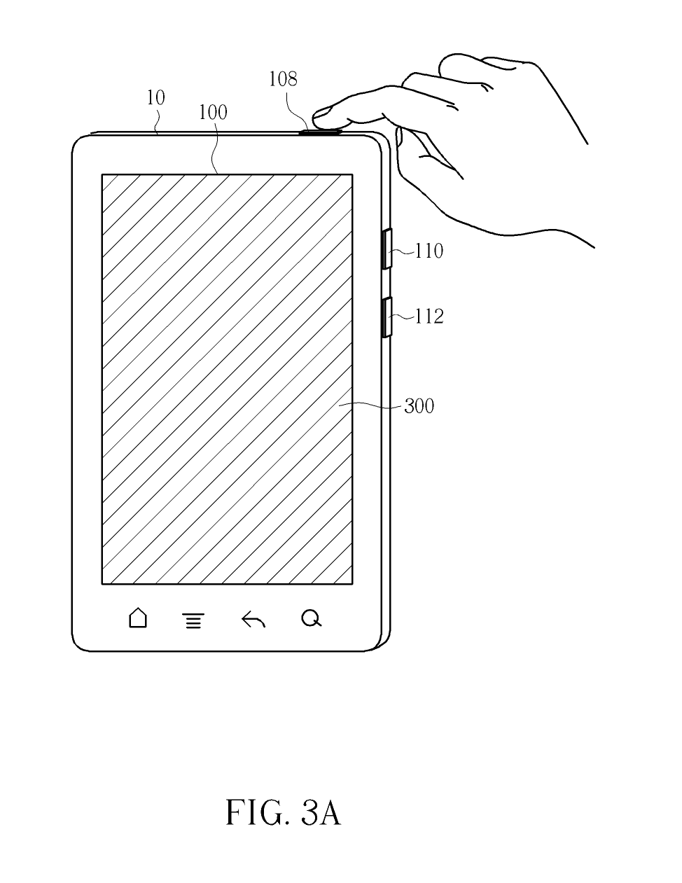

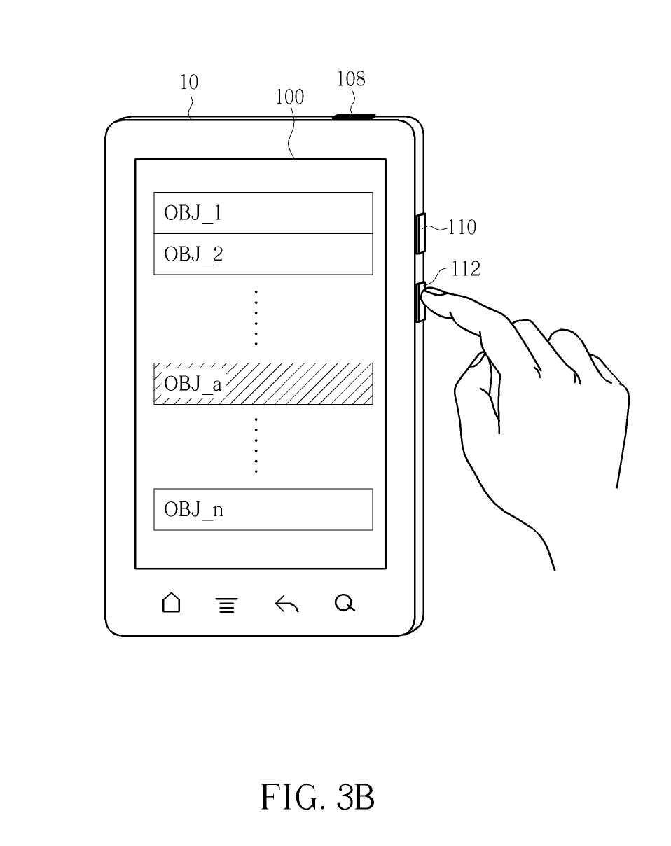

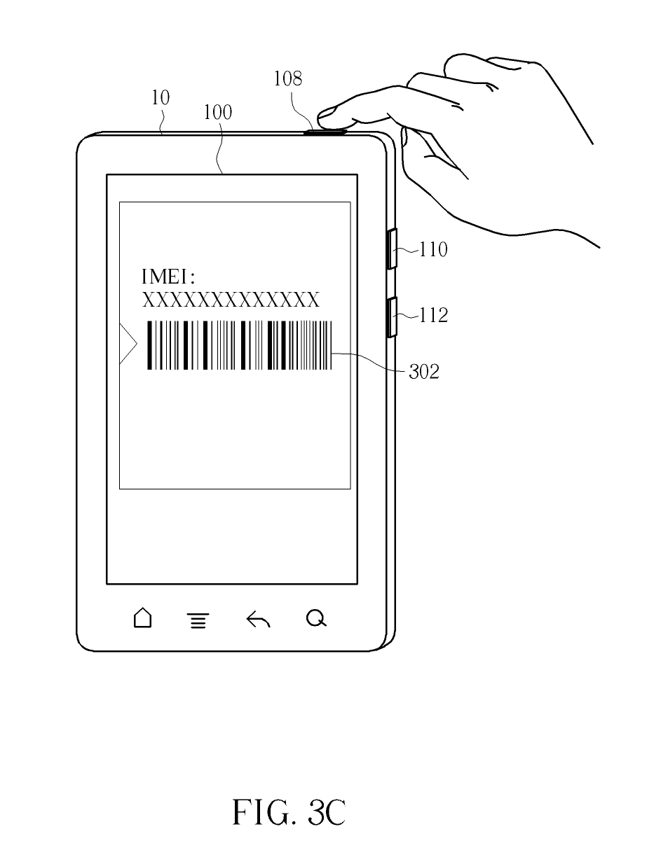

In detail, please refer to FIG. 3A, FIG. 3B, and FIG. 3C, which illustrate schematic diagrams of the screen 100 displaying ID information according to the process 20. As shown in FIG. 3A, after a user activates the power button 108 (i.e. the first button in step 202) for the predefined period, a command to perform the process 20 is generated and the electronic device 10 displays a predefined flame 300, which may be a black frame, a white frame, or other user-defined frames, to notify the user that the command is confirmed and the process 20 will be initiated. Noticeably, since the power button 108 is seldom activated during normal operations except for powering on/off, the process 20 can be prevented to be unintentionally performed during normal operations. Moreover, for distinguishing between powering on/off and generating the command, a activated period of the power button 108 for generating the command to perform the process 20 is needed to be greater than a activated period for powering on/off, for example, ten seconds. In such a condition, after the power button 108 is activated for the predefined period (e.g. ten seconds), the predefined flame is displayed and continues to be kept.

Next, as shown in FIG. 3B, when the user releases the power button 108 of the electronic device 10, selecting objects OBJ_{—}1-OBJ_n are demonstrated on the screen 100. The user may utilize the volume up button 110 and the volume down button 112 to move a cursor up and down among the selecting objects OBJ_{—}1-OBJ_n to select a specified object. In the selecting objects OBJ_{—}1-OBJ_n, a selecting objects OBJ_a is to control the electronic device 10 to display an encoded barcode of the ID information. After the user selects the selecting objects OBJ_a, the user may activate the power button 108 to trigger the selecting object OBJ_a. As a result, a barcode 302 and a related IMEI number are displayed on the screen 100, as shown in FIG. 3C. In such a situation, the user may directly scan the barcode 302 on the screen 100 to obtain the ID information by a barcode reader, and the electronic device 10 may not need to be labeled symbols of the ID information on or inside a back cover.

Note that, the present invention is capable of providing the ID information of the electronic device 10 via the screen 100; thus, the ID information on the electronic device 10 may not have been labeled. Suitable modifications or variations may be made by those skilled in the art, and are not limited to the examples above. For example, other than activating for a predefined period, the command to initiate the process 20 may be generated upon the power button 108 being activated twice, or upon another button being activated, and are not limited herein. The major purpose that the command is generated after the power button 108 is activated for the predefined period is to prevent the user from unintentionally performing displaying of the ID information and on/off functions during normal operations, and any use of existing hardware or software buttons to archive the above purpose are all adapted to the present invention.

Additionally, in the above example, the selecting objects OBJ_{—}1-OBJ_n are demonstrated on the same layer. However, in other examples, the screen 100 may not show all the selecting objects OBJ_{—}1-OBJ_n in one page. In such a situation, the user may use the volume up button 110 and the volume down button 112 to scroll the selecting objects OBJ_{—}1-OBJ_n; or, the selecting objects OBJ_{—}1-OBJ_n may be divided into several pages, and the user may use the volume up button 110 and the volume down button 112 or select some objects to change pages; or, some of the selecting objects OBJ_{—}1-OBJ_n may be grouped as a new selecting object, and the user may select the new selecting object to view the grouped selecting objects.

Moreover, each of the selecting objects OBJ_{—}1-OBJ_n may be a text-based item to indicate an operating process, e.g. the selecting objects OBJ_a may be named as “SHOW_BARCODE”, and the selecting objects OBJ_{—}1-OBJ_n form a list of text-based items. Alternatively, the selecting objects OBJ_{—}1-OBJ_n may be equal-sized rectangular icons shown in the screen 100. In addition, as shown in FIG. 3B, the volume up button 110 and the volume down button 112 are used to move the cursor. However, in other examples, the electronic device 10 may include a touch control mechanism; thus, the user may directly touch one of the selecting objects OBJ_{—}1-OBJ_n shown in the screen 100 to trigger the selecting object.

Besides, as shown in FIG. 3C, the ID information is displayed by a picture of the barcode 302. In other examples, the ID information may be displayed by a picture of QR-code, which is not limited thereto.

Additionally, except for the “SHOW_BARCODE” function triggered by the selecting object OBJ_a, other selecting objects may used to trigger other functions, e.g. “FACTOTY_RESET” for resetting the electronic device 10 to factory setting, “FAST_BOOT” for rebooting the electronic device 10 at once, “TX_IMEI” for transmitting the IMEI to an external device such as a PC or a smart phone, etc. The “TX_IMEI” function may be implemented by wireless communication technologies, such as near field communication (NFC), WiFi, WiFi Direct, Bluetooth, wireless local area network, etc.

Noticeably, in the above example, the power button 108 is utilized to control the electronic device 10 to start demonstrating the selecting objects OBJ_{—}1-OBJ_n (named initiation stage) and to confirm the selection of the selection object OBJ_a (named confirmation stage). However, the initiation and confirmation stages may be triggered by two different buttons; for example, the initiation stage may be triggered by the power button 108, and the confirmation stage may be triggered by a home control button, a shot control button, or vise versa. In addition, the power button 108, the volume up button 110 and the volume down button 112 shown in FIG. 1A are examples for illustrating the present invention, which may be replaced by other buttons, such as the shot control button, software buttons, etc.

In the context of this disclosure, a non-transitory computer-readable medium stores program for use by an instruction execution system, apparatus, or device. In this regard, one example, among others, is a non-transitory computer-readable medium embodying a program executable in a computing device such as the electronic device 10 in FIG. 1. In accordance with such examples, the program comprises code for demonstrating the plurality of selecting objects via the screen 100 when the power button 108 of the electronic device 10 is detected to be activated for a predefined period, and code for displaying the identification information of the electronic device 10 via the screen 100 when the first selecting object of the plurality of selecting objects is triggered.

In the prior art, an electronic device manufacturer has to label an IMEI on an electronic device, and the user or repairer needs to open a back cover of the electronic device to obtain the IMEI, which causes inconvenience and the cost of labeling the IMEI. In comparison, the present invention can provide the IMEI or other ID information of the electronic device via a screen, such that the electronic device manufacturer may not have to label the ID information on the electronic device and the user or repairer does not need to open the back cover of the electronic device to obtain the IMEI. Thus, the present invention can enhance convenience.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method, for providing identification information of an electronic device having a screen comprising:
demonstrating a plurality of selecting objects via the screen when a first button of the electronic device is detected to be activated for a predefined period; and
displaying the identification information of the electronic device via the screen when a first selecting object of the plurality of selecting objects is triggered.

2. The method of claim 1, wherein the first button is a power button of the electronic device.

3. The method of claim 1, wherein the step of demonstrating the plurality of selecting objects via the screen when the first button of the electronic device is detected to be activated for the predefined period, comprises:
displaying a predefined flame on the screen until the first button of the electronic device is released; and
demonstrating the plurality of selecting objects via the screen.

4. The method of claim 3, wherein the predefined flame is a black flame.

5. The method of claim 1, wherein displaying the identification information of the electronic device via the screen is displaying a picture corresponding to the identification information of the electronic device via the screen.

6. The method of claim 5, wherein the picture is a barcode.

7. The method of claim 5, wherein the picture is a QR code.

8. The method of claim 1, wherein when the first selecting object of the plurality of selecting objects is selected by a second button of the electronic device and a third button of the electronic device is activated, the first selecting object of the plurality of selecting objects is determined to be triggered.

9. The method of claim 8, wherein the second button is a volume control button of the electronic device.

10. The method of claim 8, wherein the third button is a power button of the electronic device.

11. The method of claim 1, further comprising:
transmitting the information of the electronic device identification to an external device when a second selecting object of the plurality of selecting objects is triggered.

12. The method of claim 11, wherein when the second selecting object of the plurality of selecting objects is selected by a second button of the electronic device and a third button of the electronic device is activated, the second selecting object of the plurality of selecting objects is determined to be triggered.

13. The method of claim 12, wherein the second button is a volume control button of the electronic device.

14. The method of claim 12, wherein the third button is a power button of the electronic device.

15. A non-transitory computer-readable medium embodying a program executable in a computing device, the program comprising:
code for demonstrating a plurality of selecting objects via the screen when a first button of the electronic device is detected to be activated for a predefined period; and
code for displaying the identification information of the electronic device via the screen when a first selecting object of the plurality of selecting objects is triggered.

16. The non-transitory computer-readable medium of claim 15, wherein the first button is a power button of the electronic device.

17. The non-transitory computer-readable medium of claim 15, wherein code for demonstrating the plurality of selecting objects via the screen when the first button of the electronic device is detected to be activated for the predefined period, comprises:
code for displaying a predefined flame on the screen until the first button of the electronic device is released; and
code for demonstrating the plurality of selecting objects via the screen.

18. The non-transitory computer-readable medium of claim 17, wherein the predefined flame is a black flame.

19. The non-transitory computer-readable medium of claim 15, wherein code for displaying the identification information of the electronic device via the screen is code for displaying a picture corresponding to the identification information of the electronic device via the screen.

20. The non-transitory computer-readable medium of claim 19, wherein the picture is a barcode.

21. The non-transitory computer-readable medium of claim 19, wherein the picture is a QR code.

22. The non-transitory computer-readable medium of claim 15, wherein when the first selecting object of the plurality of selecting objects is selected by a second button of the electronic device and a third button of the electronic device is activated, the first selecting object of the plurality of selecting objects is determined to be triggered.

23. The non-transitory computer-readable medium of claim 22, wherein the second button is a volume control button of the electronic device.

24. The non-transitory computer-readable medium of claim 22, wherein the third button is a power button of the electronic device.

25. The non-transitory computer-readable medium of claim 15, further comprising:
code for transmitting the information of the electronic device identification to an external device when a second selecting object of the plurality of selecting objects is triggered.

26. The non-transitory computer-readable medium of claim 25, wherein when the second selecting object of the plurality of selecting objects is selected by a second button of the electronic device and a third button of the electronic device is activated, the second selecting object of the plurality of selecting objects is determined to be triggered.

27. The non-transitory computer-readable medium of claim 26, wherein the second button is a volume control button of the electronic device.

28. The non-transitory computer-readable medium of claim 26, wherein the third button is a power button of the electronic device.

29. An electronic device, comprising:
a screen, for displaying data;
a processing means; and
a storage unit, for storing a program to indicate the processing means to perform the following steps:
demonstrating a plurality of selecting objects via the screen when a first button of the electronic device is detected to be activated for a predefined period; and
displaying the identification information of the electronic device via the screen when a first selecting object of the plurality of selecting objects is triggered.

30. The electronic device of claim 29, wherein the first button is a power button of the electronic device.

31. The electronic device of claim 29, wherein the step of demonstrating the plurality of selecting objects via the screen when the first button of the electronic device is detected to be activated for the predefined period, comprises:
displaying a predefined flame on the screen until the first button of the electronic device is released; and
demonstrating the plurality of selecting objects via the screen.

32. The electronic device of claim 31, wherein the predefined flame is a black flame.

33. The electronic device of claim 29, wherein displaying the identification information of the electronic device via the screen is displaying a picture corresponding to the identification information of the electronic device via the screen.

34. The electronic device of claim 33, wherein the picture is a barcode.

35. The electronic device of claim 33, wherein the picture is a QR code.

36. The electronic device of claim 2, wherein when the first selecting object of the plurality of selecting objects is selected by a second button of the electronic device and a third button of the electronic device is activated, the first selecting object of the plurality of selecting objects is determined to be triggered.

37. The electronic device of claim 36, wherein the second button is a volume control button of the electronic device.

38. The electronic device of claim 36, wherein the third button is a power button of the electronic device.

39. The electronic device of claim 29, further comprising:
transmitting the information of the electronic device identification to an external device when a second selecting object of the plurality of selecting objects is triggered.

40. The electronic device of claim 39, wherein when the second selecting object of the plurality of selecting objects is selected by a second button of the electronic device and a third button of the electronic device is activated, the second selecting object of the plurality of selecting objects is determined to be triggered.

41. The electronic device of claim 40, wherein the second button is a volume control button of the electronic device.

42. The electronic device of claim 40, wherein the third button is a power button of the electronic device.
